(19) United States
(12) Patent Application Publication
(10) Pub. No.: US 2013/0102257 A1
(43) Pub. Date: Apr. 25, 2013

(54) MOBILE SENSOR AND COMMUNICATION DEVICE

(71) Applicants: Bharat V. Bedi, Portsmouth (GB); Wilfredo Ferre, Les Mesnil le Roi (FR); Nicola Palmarini, Milan (IT); Marc Yvon, Antony (FR)

(72) Inventors: Bharat V. Bedi, Portsmouth (GB); Wilfredo Ferre, Les Mesnil le Roi (FR); Nicola Palmarini, Milan (IT); Marc Yvon, Antony (FR)

(73) Assignee: INTERNATIONAL BUSINESS MACHINES CORPORATION, Armonk, NY (US)

(21) Appl. No.: 13/353,430

(22) Filed: Jan. 19, 2012

(30) Foreign Application Priority Data
Oct. 20, 2011 (EP) 11306357.2

(51) Int. Cl. H04W 4/00

(52) U.S. Cl. 455/66.1; 455/73; 901/1

(57) ABSTRACT

A device including an enclosure secured to a mobile entity, wherein the enclosure includes a first sensor module for obtaining first sensor information; and a radio frequency (RF) device for receiving the first sensor information and transmitting a first communication signal.

### BACKGROUND OF THE INVENTION

This invention relates generally to sensors and more particularly to a mobile sensor and communication device.

When natural or man-made disasters such as flood, earthquake, tornado, volcano eruption, landslide, fire, terrorist attacks occur, they impact the population and workforce by disconnecting them from normal life. Families, companies, governments etc. do not know where the people are or might be. They do not have the means to get in touch nor to communicate with them. They do not know if they are alive or injured, do not know if they can still work, and at an organization level have a difficult time optimizing rescue, assistance and logistics.

Furthermore, in times where more and more people are concentrated in cities, disasters impact a lot of people at once and on a large scale. Disasters could happen in cases of terrorist attacks (bombs, . . . ); in unexpected geographical zones; and/or in very crowded areas (concerts, trains, airport, . . . ). There is no digital system to identify the whereabouts of people affected by a disaster or a communication system to get relevant information related to their health or their abilities such as ability to walk, talk, move, or work.

### SUMMARY OF THE INVENTION

A first aspect of the invention includes a device, comprising: an enclosure secured to a mobile entity, wherein the enclosure includes: a first sensor module for obtaining first sensor information; and a radio frequency (RF) device for receiving the first sensor information and transmitting a first communication signal.

A second aspect of the invention includes a mobile robotic device, comprising: a first sensor module for obtaining first sensor information; and a radio frequency (RF) device for receiving the first sensor information and transmitting a first communication signal.

A third aspect of the invention includes a system, comprising: a plurality of mobile robotic devices, each mobile robotic device including: a first sensor module for obtaining first sensor information; and a radio frequency (RF) device for receiving the first sensor information and transmitting a first communication signal; and a base station for communicating with each RF device.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 depicts one embodiment of a device in accordance with this invention.

FIG. 2 depicts one embodiment of a device in accordance with this invention.

FIG. 3 depicts one embodiment of a network in accordance with this invention.

FIG. 4 depicts one embodiment of a computer system in accordance with this invention.

FIG. 5 depicts an illustration of one device in operation in accordance with the invention.

FIG. 6 depicts an illustration of three devices in operation in accordance with the invention.

FIG. 7 depicts an illustration of three devices in operation in accordance with the invention.

FIG. 8 depicts an illustration of one device in operation in accordance with the invention.

FIG. 9 depicts an illustration of three devices in operation in accordance with the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

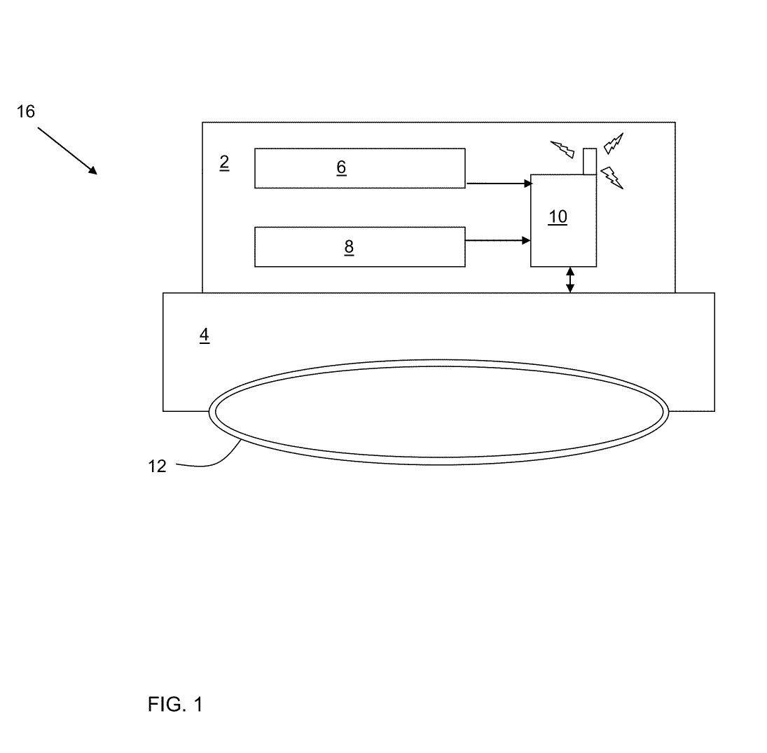

Referring to FIG. 1, one embodiment of a mobile sensor and communication device (MSCD) 16 in accordance with the invention is shown. MSCD 16 may include an enclosure 2. Enclosure 2 may be secured to a mobile entity 4. Enclosure 2 may include a first sensor module 6 for obtaining a first sensor information, a second sensor module 8 for obtaining a second sensor information, and a radio frequency (RF) device 10 for transmitting a first communication signal.

Mobile entity 4 may include, for example, a machine or an animal. In the case of machine, FIG. 1 illustrates a tank tread 12 for providing mobility to mobile entity 4. Mobile entity 4 may include a robotic device including mechanical legs, wheels, flight capacity, or any other now known or to be developed method for providing mobility to mobile entity 4. In the case of animal, mobile entity 4 could be any animal that has the physical capacity to have enclosure 2 secured to the animal.

First sensor module 6 and second sensor module 8 are illustrated in FIG. 1. MSCD 16 may include any number of sensors including one sensor. Each sensor may include any now known or to be developed sensor for detecting a condition of an object or an environment including but not limited to a chemical sensor, a gas concentration sensor, a temperature sensor, a vibration sensor, a pressure sensor, a particulate concentration sensor, a humidity sensor, a biosensor, a light sensor, a motion sensor, a magnetic sensor, a gravity sensor, and a sound sensor.

RF device 10 may communicate using any now known or to be developed RF communications protocol. RF device 10 may transmit first communication signal including first sensor information and second sensor information. RF device 10 may be in communication with mobile entity 4. RF device 10 may receive a second communication signal from outside MSCD 16 including, for example, a directive information, a survivor information, and a rescuer information. RF device 10 transmits the directive information in the second communication signal to the mobile entity 4. Directive information may include instructions for mobile entity 4 including but not limited to moving, stopping, and changing directions. Survivor information may include, for example, instructions on how to treat an injury or how to escape from the structure. Rescuer information may include, for example, instructions on how to reach places and people, how to treat injuries, and how to support damaged structural components.

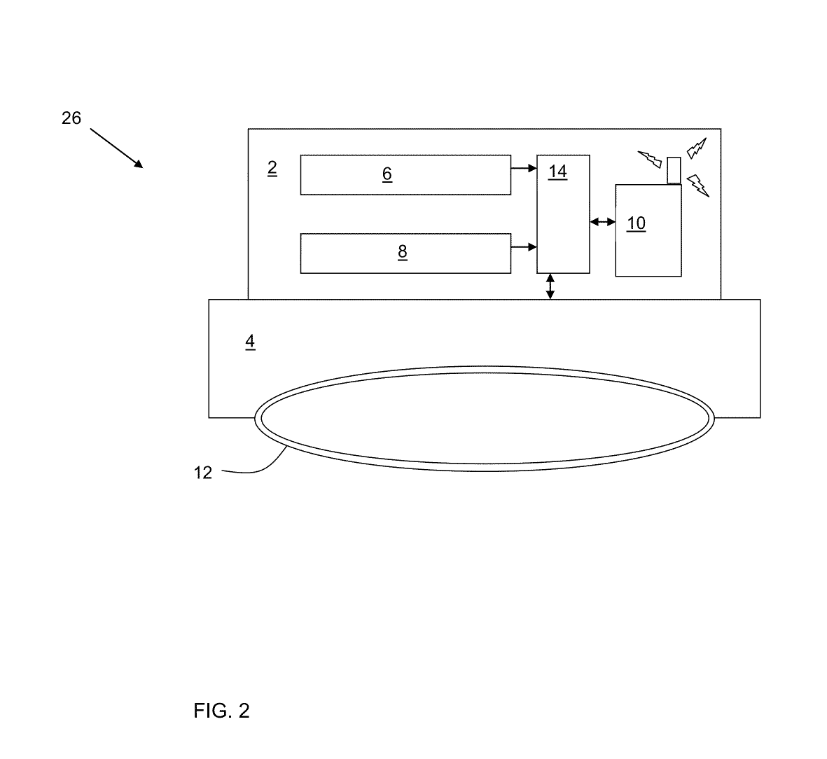

Referring to FIG. 2, one embodiment of a mobile sensor and communication device (MSCD) 26 in accordance with the invention is shown. MSCD 26 is the same as embodiment in FIG. 2 with the exception of enclosure 2 including a microprocessor 14. Microprocessor 14 may receive first sensor information and second sensor information and calculate an environment information. For example, in one embodiment first sensor module 6 may be an accelerometer for providing movement information and second sensor module 8 may be a barometer for providing atmospheric information. Microprocessor 14 may utilize the movement information and atmospheric information, for example, to estimate the location of MSCD 26. Accordingly, RF device 10 may transmit, in addition to first sensor information and second sensor information, the estimated location of MSCD 26.

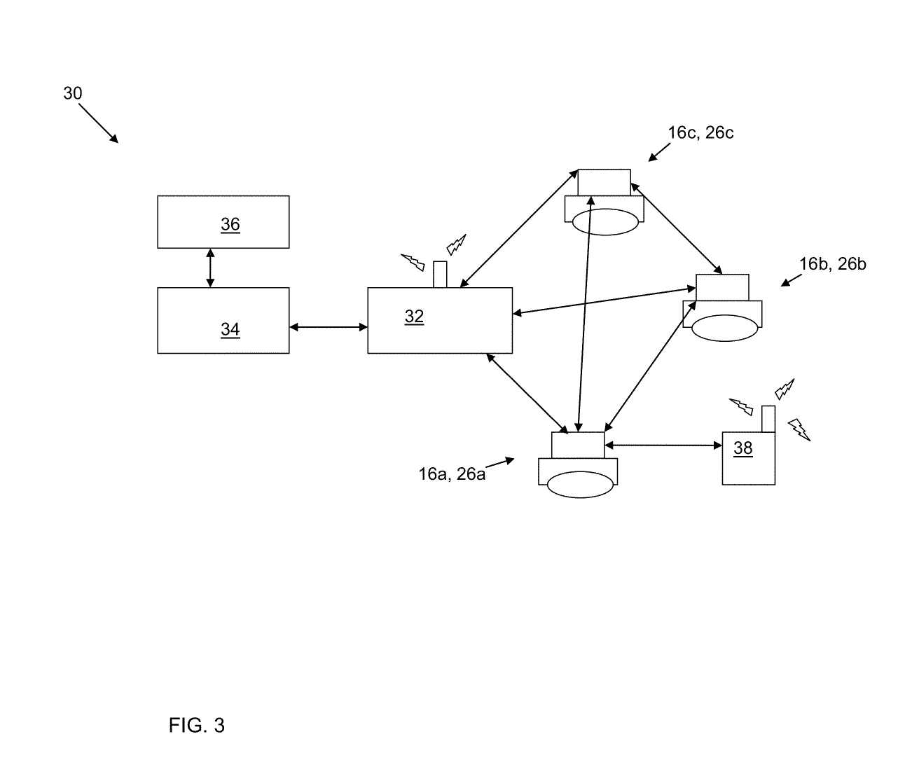

Referring to FIG. 3, an embodiment of a network 30 in accordance with the invention is shown. Network 30 includes a plurality of MSCD 16 (e.g 16a-16c), 26 (e.g. 26a-26c), an RF tower 32 for receiving and communicating sensor information from plurality of MSCD 16, 26, and a computer system 34 receiving sensor information from the RF tower 32 and processing sensor information. Plurality of MSCD 16,26 may all be the same embodiment or different embodiments. Each MSCD 16, 26 may communicate with any other MSCD 16, 26. RF tower 32 may receive RF signals from each MSCD 16, 26 using any compatible communications protocol including WiFi, Bluetooth, Zigbee, RFID, and any other now known or to be developed communications protocol. RF tower 32 communicates sensor information received from each MSCD 16, 26. Computer system 34 may receive data from RF tower 32 and calculate environment information from the sensor information in any now known or to be developed manner. Computer system 34 is shown in communication with user 36. User 36 may, for example, be a programmer or operator. User 36 may also be a device or a computer. User 36 may be a single device or computer or a plurality of devices or computers. Network 30 may include a mobile RF device 38 for communicating with each MSCD 16, 26. Network 30 may be deployed in any setting or environment. In FIG. 3, three MSCDs 16, 26 are illustrated but any number of MSCDs 16, 26 may be used including one. Further, each MSCD 16, 26 may be any embodiment of device and combination of embodiments of device described herein.

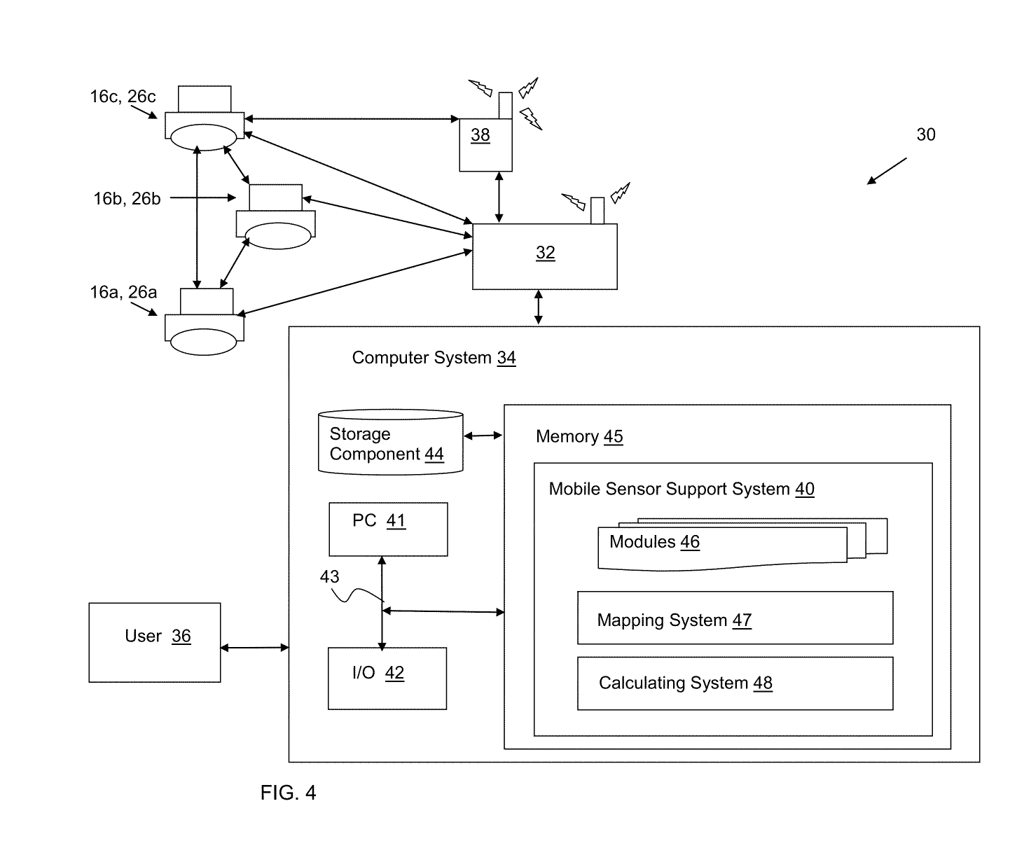

In FIG. 4, computer system 34 includes a mobile sensor support system 40 stored in a memory 45 and described herein. Computer system 34 is shown including a processing component (PC) 41 (e.g., one or more processors), a storage component 44 (e.g., a storage hierarchy), an input/output (I/O) component 42 (e.g., one or more I/O interfaces and/or devices), and a communications pathway 43. In one embodiment, processing component 41 executes program code, such as mobile sensor support system 40, which is at least partially embodied in storage component 44. While executing program code, processing component 41 can process data, which can result in reading and/or writing the data to/from storage component 44 and/or I/O component 42 for further processing. Pathway 43 provides a communications link between each of the components in computer system 34. I/O component 42 can comprise one or more human I/O devices or storage devices, which enable user 36 to interact with computer system 34 and/or one or more communications devices to enable user 36 to communicate with computer system 34 using any type of communications link. To this extent, mobile sensor support system 40 can manage a set of interfaces (e.g., graphical user interface(s), application program interface, and/or the like) that enable human and/or system interaction with mobile sensor support system 40.

In any event, computer system 34 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, mobile sensor support system 40 can be embodied as any combination of system software and/or application software. In any event, the technical effect of computer system 34 is to provide calculation of environmental information from sensor information and mapping of environments based upon environmental information and/or sensor information.

Further, mobile sensor support system 40 can be implemented using a set of modules 46. In this case, a module 46 can enable computer system 34 to perform a set of tasks used by mobile sensor support system 40, and can be separately developed and/or implemented apart from other portions of mobile sensor support system 40. Mobile sensor support system 40 may include modules 46 which comprise a specific use machine/hardware and/or software. Regardless, it is understood that two or more modules 46, and/or systems may share some/all of their respective hardware and/or software. Further, it is understood that some of the functionality discussed herein may not be implemented or additional functionality may be included as part of computer system 34.

When computer system 34 comprises multiple computing devices, each computing device may have only a portion of mobile sensor support system 40 embodied thereon (e.g., one or more modules 46). However, it is understood that computer system 34 and mobile sensor support system 40 are only representative of various possible equivalent computer systems that may perform a process described herein. To this extent, in other embodiments, the functionality provided by computer system 34 and mobile sensor support system 40 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 34 includes multiple computing devices, the computing devices can communicate over any type of communications link. Further, while performing a process described herein, computer system 34 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, mobile sensor support system 40 enables computer system 34 to calculate environmental information from sensor information and map environments based upon environmental information and/or sensor information. Mobile sensor support system 40 may include logic, which may include the following functions: mapping system 47 for mapping the environment and calculating system 48 for calculating environmental information. In one embodiment, mobile sensor support system 40 may include logic to perform the above-stated functions. Structurally, the logic may take any of a variety of forms such as a field programmable gate array (FPGA), a microprocessor, a digital signal processor, an application specific integrated circuit (ASIC) or any other specific use machine structure capable of carrying out the functions described herein. Logic may take any of a variety of forms, such as software and/or hardware. However, for illustrative purposes, mobile sensor support system 40 and logic included therein will be described herein as a specific use machine. As will be understood from the description, while logic is illustrated as including each of the above-stated functions, not all of the functions are necessary according to the teachings of the invention as recited in the appended claims.

While shown and described herein as mobile sensor support system 40, it is understood that aspects of the invention further provide various alternative embodiments. For example, in one embodiment, the invention provides a computer program embodied in at least one computer-readable medium, which when executed, enables a computer system to calculate environmental information from sensor information and map environments based upon environmental information and/or sensor information. To this extent, the computer-readable medium includes program code, such as mobile sensor support system 40, which implements some or all of a process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; paper; and/or the like.

In still another embodiment, the invention provides a method of calculating environmental information from sensor information and mapping environments based upon environmental information and/or sensor information. In this case, a computer system, such as computer system 34, can be obtained (e.g., created, maintained, made available, etc.) and one or more modules 46 for performing a process described herein can be obtained (e.g., created, purchased, used, modified, etc.) and deployed to the computer system. To this extent, the deployment can comprise one or more of: (1) installing program code on a computing device from a computer-readable medium; (2) adding one or more computing and/or I/O devices to the computer system; and (3) incorporating and/or modifying the computer system to enable it to perform a process described herein.

It is understood that aspects of the invention can be implemented as part of a business method that performs a process described herein on a subscription, advertising, and/or fee basis. That is, a service provider could offer to provide processing instructions for calculating environmental information from sensor information and mapping environments based upon environmental information and/or sensor information as described herein. In this case, the service provider can manage (e.g., create, maintain, support, etc.) a computer system, such as computer system 34, that performs a process described herein for one or more customers. In return, the service provider can receive payment from the customer(s) under a subscription and/or fee agreement, receive payment from the sale of advertising to one or more third parties, and/or the like.

Calculating system 48 may calculate the environment information using first sensor information, second sensor information, and any additional sensor information from the MSCDs 16, 26. Environment information may include locations of MSCDs 16, 26; location of objects; concentrations of chemicals, explosive concentrations, oxygen levels, and any other data that may be derived from a plurality of sensor information.

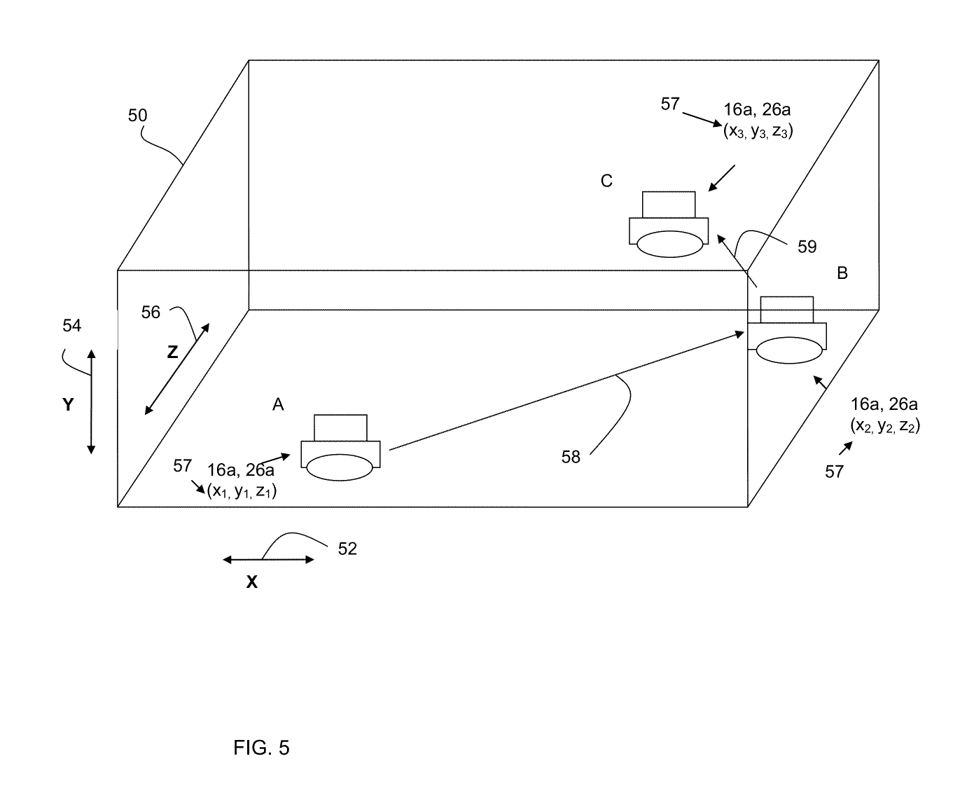

Mapping system 47 may create a map of environment 50 (FIG. 5) including the location of MSCDs. Creating the map may utilize sensor information and environment information. Mapping system 47 may utilize environment information stored in storage component 44. For example, the plans of a structure may be stored in storage component 44 and provide a basis for mapping the environment 50. As further example, MSCDs 16, 26 may be utilized to map the environment 50 and store mapping in formation in storage component 44. At a later date, the map of the environment 50 at a previous date may be utilized to map the environment 50 at the later date.

Referring to FIG. 5, an illustration of one MSCD 16a in operation in accordance with the invention is shown. MSCD 16a may be deployed in an environment 50. Environment 50 is illustrated in three dimensions (x coordinate 52, y coordinate 54, and z coordinate 56). A person skilled in the art will readily recognize that environment 50 may be two dimensions. Environment 50 may include any measurable space. Environment 50 may include man made structures such as buildings, bridges, tunnels, etc., natural environments such as fields, mountains, caves, etc, man made environments such as cities, piers, airports, etc. and any combination of these. MSCD 16a is shown at three different locations A, B, and C, each location defined by the x, y, and z coordinates 52, 54, 56. MSCD 16a begins at A with a location coordinate 57 (e.g. x₁, y₁, z₁). The location coordinate 57 may be provided to the MSCD 16a or measured by the MSCD 16a using the accelerometer and/or the barometer or a combination of provided and measured coordinates. MSCD 16a moves from A to B along first path 58. MSCD 16a may obtain the location coordinate 57 at B (e.g. x₂, y₂, z₂). Each location coordinate 57 at A and B may be compared to map the first path 58 in the environment 50. MSCD 16a moves from B to C along second path 59. MSCD 16a may obtain the location coordinate 57 at C (e.g. x₃, y₃, z₃). Each location coordinate 57 at B and C may be compared to map the second path 59 in the environment 50. Any number of movements of MSCD 16a within the environment 50 may be performed. Each movement may result in the mapping of another path within the environment 50. In FIG. 5, any embodiment of MSCD 16, 26 may be operated in environment 50. Each path identified by MSCD 16, 26, may be used, for example, for people entering the environment 50 or by people exiting the environment 50. For example, having various paths defined after a disaster to the environment 50 the search for and rescue of both animate (e.g. people, animals, and plants) and inanimate objects (various non-living assets e.g. documents, art objects, etc.) may be facilitated.

In addition to location and path analysis, location coordinates 57 may be used for spatial volume analysis. Sensor information from such sensors as chemical sensors, gas concentration sensors, temperature sensors may used in conjunction with spatial volume to determine toxicity of environments, life supporting environments, explosive environments, or any other condition based upon concentrations of substances within the environment 50.

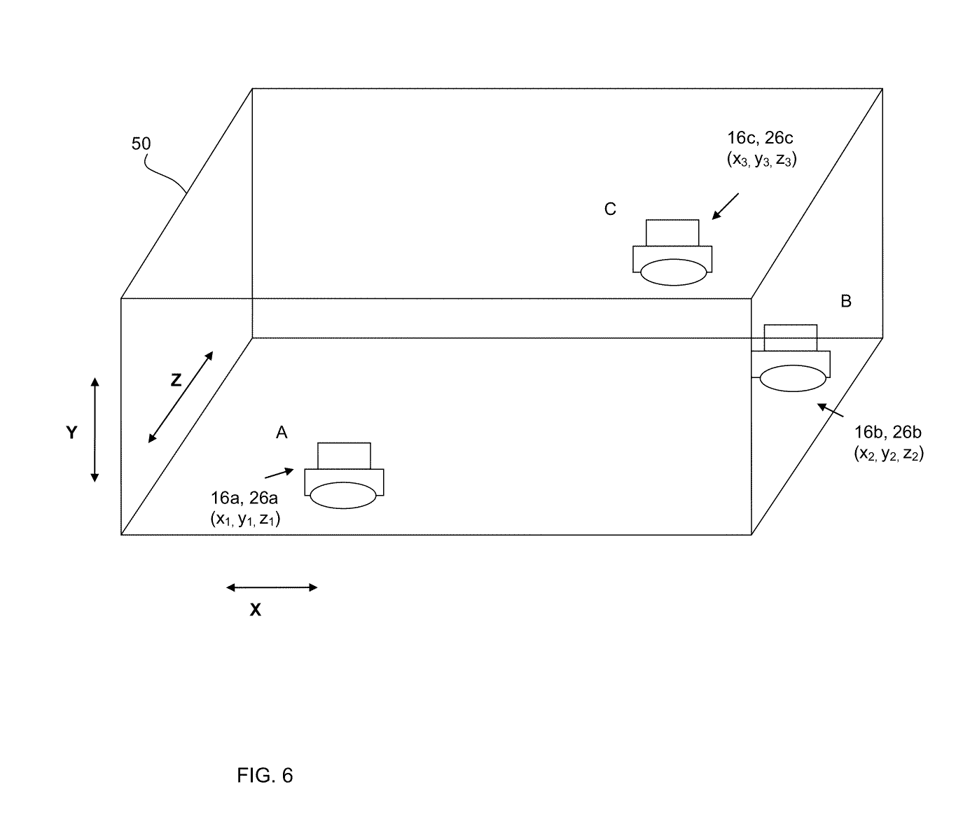

Referring to FIG. 6, an illustration of three MSCDs 16a, 16b, and 16c in operation in accordance with the invention is shown. In FIG. 6, each of the MSCD 16a, 16b, 16c obtain the location coordinates 57. Each MSCD 16a, 16b, and 16c may communicate sensor information and/or location coordinates 57 with other MSCDs 16a, 16b, and 16c. Alternatively, the MSCDs 16a, 16b, and 16c may be deployed as part of a network as described in FIG. 3 herein.

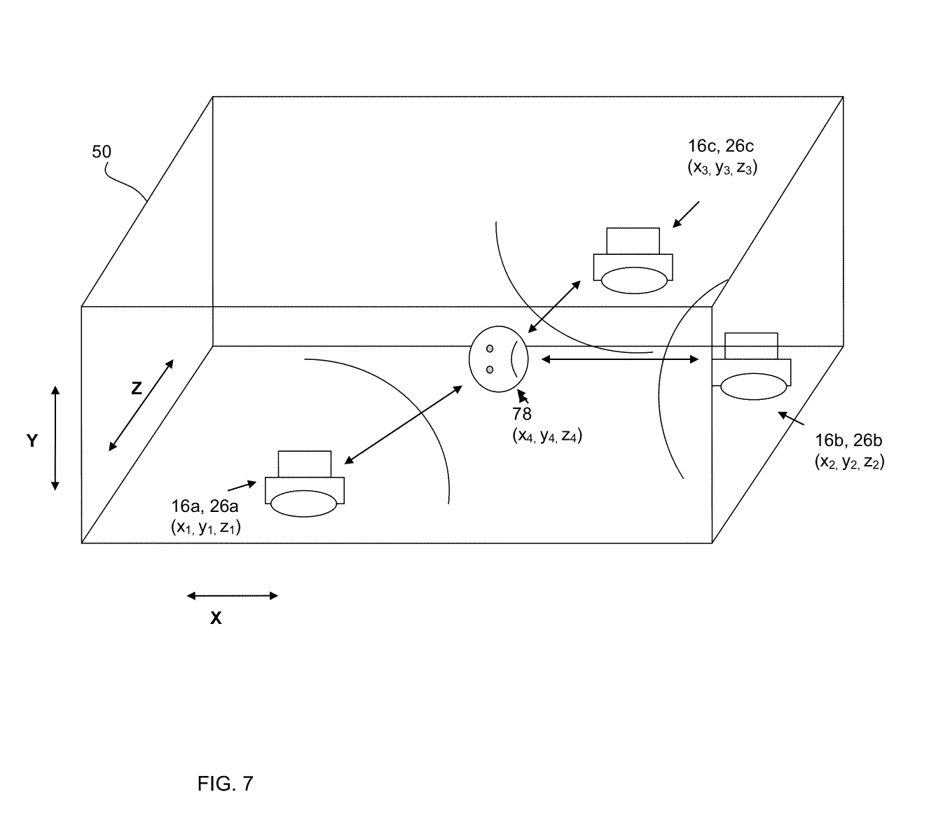

Referring to FIG. 7, an illustration of three MSCDs 16a, 16b, and 16c in operation in accordance with the invention is shown. A person 78 may be located by at least three MSCDs 16a, 16b, and 16c by triangulation of RF signals to person 78 in conjunction with location coordinates 57 of each MSCD 16a, 16b, and 16c. Identifying the location of the person 78 within environment 50 may assist either the person 78 in determining where they are and how to get out of the environment 50, may assist rescuers in reaching the person 78 for rescue, to provide sustenance, and or to provide medical care. Further MSCD 16a, 16b, 16c may communicate with person 78 and thereby may facilitate communication with others via RF tower 32 (FIG. 3) or mobile device 38.

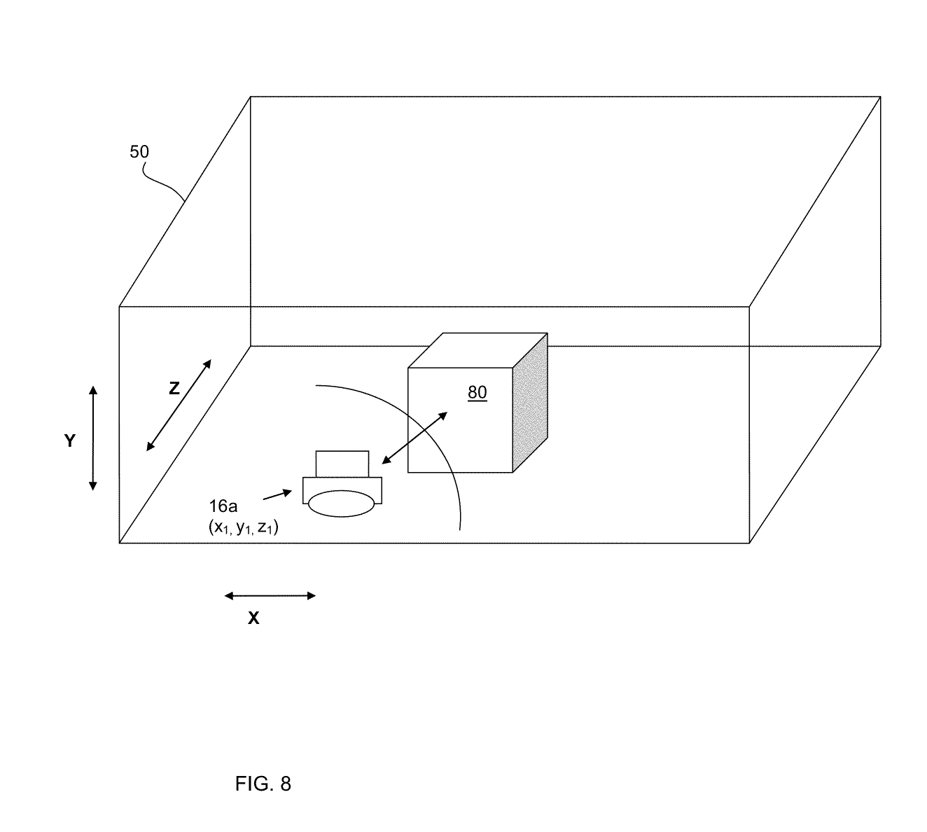

Referring to FIG. 8, an illustration of one MSCD 16a in operation in accordance with the invention is shown. MSCD 16a may be deployed in an environment 50 and encounter an object 80. Object 80 may be a wall, floor, ceiling, structure, or any other animate or inanimate object as described herein. Using RF signals MSCD 16a may determine, for example, location, size, and shape of object 80. This information may be communicated by MSCD 16a to RF tower 32 (FIG. 3) and/or mobile device 38 (FIG. 3). Potential uses of information may include determining information about bombs, obstacles to rescue, and animate or inanimate objects for providing assistance or rescue.

Other uses of MSCDs 16, 26 in accordance with embodiments described herein include mapping paths and locations within the environment 50 before any kind of event such as disaster, collapse, or other hazardous event such as release of toxic gases, radioactivity, or other environmental hazards. Mapping environment 50 prior to the event would provide information about the environment 50 that could be stored on computer system 34 (FIG. 4) or any other now known or to be developed device that includes data storage and compared to information obtained by MSCD 16, 26 after the event.

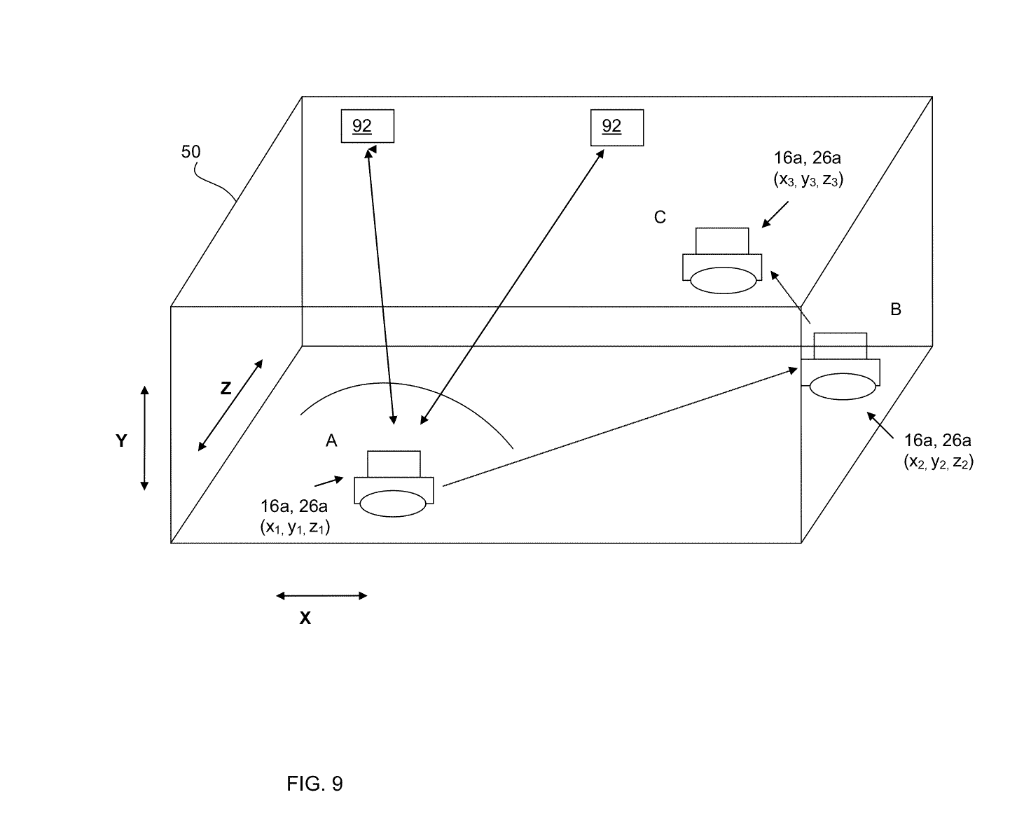

Referring to FIG. 9, an illustration of one MSCD 16a, 26a in operation in accordance with the invention is shown. Similarly to FIG. 5, MSCD 16a, 26a may be deployed in an environment 50. In FIG. 9, environment 50 includes RF reference points 92. RF reference points 92 may include, for example, WiFi access points or RFID tags installed in the environment 50. MSCD 16a, 26a may communicate with RF reference points 92 determining their location before and/or after the event in the environment 50 and communicating status of the environment 50 based upon the location of the RF reference points 92. In FIG. 9, communication between MSCD 16a, 26a at location A and RF reference points 92 is illustrated but a person skilled in the art will readily recognize that MSCD 16a, 26a may communicate with RF reference points 92 at any location in the environment 50.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
an enclosure secured to a mobile entity, wherein the enclosure includes:
a first sensor module for obtaining first sensor information; and
a radio frequency (RF) device for receiving the first sensor information and transmitting a first communication signal.

2. The device of claim 1, wherein the enclosure further includes a second sensor module for obtaining second sensor information.

3. The device of claim 2, wherein the enclosure further includes a microprocessor for processing the first sensor information and the second sensor information

4. The device of claim 2, wherein the first sensor module is an accelerometer and the second sensor module is a barometer.

5. The device of claim 1, wherein the first sensor module sensor includes at least one of a chemical sensor, a gas concentration sensor, a temperature sensor, a vibration sensor, a pressure sensor, a particulate concentration sensor, a humidity sensor, a biosensor, a light sensor, a motion sensor, a magnetic sensor, a gravity sensor, and a sound sensor.

6. The device of claim 2, wherein the second sensor module sensor includes at least one of a chemical sensor, a gas concentration sensor, a temperature sensor, a vibration sensor, a pressure sensor, a particulate concentration sensor, a humidity sensor, a biosensor, a light sensor, a motion sensor, a magnetic sensor, a gravity sensor, and a sound sensor.

7. The device of claim 2, wherein the RF device receives the second sensor information.

8. The device of claim 1, wherein the RF device receives a second communication signal including a directive information and transmits the directive information in the second communication signal to the mobile entity.

9. The device of claim 1, wherein the mobile entity is at least one of an animal or a robotic device.

10. A mobile robotic device, comprising:
a first sensor module for obtaining first sensor information; and
a radio frequency (RF) device for receiving the first sensor information and transmitting a first communication signal.

11. The mobile robotic device of claim 10, further comprising
a second sensor module for obtaining second sensor information.

12. The mobile robotic device of claim 11, further comprising:
a microprocessor for processing the first sensor information and the second sensor information

13. The mobile robotic device of claim 11, wherein the first sensor module is an accelerometer and the second sensor module is a barometer.

14. The mobile robotic device of claim 10, wherein the first sensor module sensor includes at least one of a chemical sensor, a gas concentration sensor, a temperature sensor, a vibration sensor, a pressure sensor, a particulate concentration sensor, a humidity sensor, a biosensor, a light sensor, a motion sensor, a magnetic sensor, a gravity sensor, and a sound sensor.

15. The mobile robotic device of claim 11, wherein the second sensor module sensor includes at least one of a chemical sensor, a gas concentration sensor, a temperature sensor, a vibration sensor, a pressure sensor, a particulate concentration sensor, a humidity sensor, a biosensor, a light sensor, a motion sensor, a magnetic sensor, a gravity sensor, and a sound sensor.

16. The mobile robotic device of claim 11, wherein the RF device receives the second sensor information.

17. The mobile robotic device of claim 10, wherein the RF device receives a second communication signal including a directive information and transmits the directive information in the second communication signal to the mobile entity.

18. A system, comprising:
a plurality of mobile robotic devices, each mobile robotic device including:
a first sensor module for obtaining first sensor information; and
a radio frequency (RF) device for receiving the first sensor information and transmitting a first communication signal; and
a base station for communicating with each RF device.

19. The device of claim 18, wherein each mobile robotic device includes:
a second sensor module for obtaining second sensor information.

20. The device of claim 19, wherein each mobile robotic device includes:
a microprocessor for processing the first sensor information and the second sensor information
